(19) United States
(12) Patent Application Publication
(10) Pub. No.: US 2023/0332740 A1
(43) Pub. Date: Oct. 19, 2023

(54) Edge Catcher Device

(71) Applicant: Donald Ansel Parrott, Hixson, TN (US)

(72) Inventor: Donald Ansel Parrott, Hixson, TN (US)

(21) Appl. No.: 17/720,126

(22) Filed: Apr. 13, 2022

(51) Int. Cl. F16M 13/02; G01C 15/00

(52) U.S. Cl. CPC F16M 13/025; G01C 15/00; F16M 2200/08

(57) ABSTRACT

An article of manufacture for providing an edge catcher device for a surveyor’s prism pole according to the present invention is an edge catching level rod comprising a level rod shaft member having a top end, a bottom end, and a vertical rod centerline, an edge catching device having a top end, an edge engaging bottom end and a vertical device centerline, and an attachment device coupling the bottom end of the level rod shaft member to the top end of the edge catching device. The edge catching device also includes the edge engaging bottom end having an upper bottom edge and a lower bottom edge, an attachment threaded hole configures to couple to an attachment device along a vertical device centerline, and an inner edge running across the bottom edge engaging bottom end and being configured to align the inner edge vertically through the vertical device centerline.

### TECHNICAL FIELD

This application relates in general to an article of manufacture for providing a surveying device, and more specifically, to an article of manufacture for providing an edge catching device for a surveyor’s prism pole.

### BACKGROUND

The work of a surveyor establishes official land, airspace, and water boundaries. Surveyors work with civil engineers, landscape architects, and regional and urban planners to develop comprehensive design documents. Surveyors work outdoors in many types of terrain, and they also work indoors to prepare legal documents and other reports. When doing this work, a surveyor may measure distances, directions, and angles between points on, above, and below the earth’s surface, select known reference points and then determine the exact location of important features in the survey area using special equipment, establish official land and water boundaries, research land records and other sources of information affecting properties, look for evidence of previous boundaries to determine where boundary lines are located, and present findings to clients, government agencies, and others in written descriptions of land for deeds, leases, and other legal documents, and provide expert testimony in court regarding their work or that of other surveyors. The accuracy of their measurements is determined by the accuracy of locating these known reference points and important features.

In their work, surveyors use the Global Positioning System (GPS), a system of satellites that locates reference points with a high degree of precision. Surveyors interpret and verify the GPS results. They gather the data that is fed into a Geographic Information System (GIS), which is then used to create detailed maps. Surveyors also take measurements in the field with a crew, a group that typically consists of a licensed surveyor and trained survey technicians. These measurements may be used to calculate locations of many items relative to each other as well as relative to a known location or property line.

When making these measurements, the surveyor uses a compass, a transit, a level, and a level rod or prism pole to measure changes in elevation for various points within an area being surveyed. In order to use these tools to accurately determine the distance, location, azimuth, and elevation change of an area, the surveyor will obtain measurements using these tools from multiple identifiable locations in an area. These identifiable locations are typically marked by objects such as trees, boulders, and man-made objects such as curbs, sidewalks, and structures. To obtain measurements of these locations as accurately as possible, the level rod or prism pole needs to be positioned at one of these identifiable objects at a known position such as an edge of a curb or other object. Ensuring that the level rod or prism pole is located at this edge of the object determines the accuracy of the measurements.

Therefore, a need exists for an article of manufacture for providing an edge catching device for a surveyor’s prism pole. The present invention attempts to address the limitations and deficiencies in prior solutions according to the principles and example embodiments disclosed herein.

### SUMMARY

In accordance with the present invention, the above and other problems are solved by providing an article of manufacture for an edge catching device for a surveyor’s prism pole according to the principles and example embodiments disclosed herein.

In one embodiment, the present invention is an article of manufacture for providing an edge catching level rod for a surveyor’s prism pole. The edge catching level rod comprising a level rod shaft member having a top end, a bottom end, and a vertical rod centerline, an edge catching device having a top end, an edge engaging bottom end and a vertical device centerline, and an attachment device coupling the bottom end of the level rod shaft member to the top end of the edge catching device.

In another aspect of the present invention, the attachment device is configured to align the vertical device centerline and the vertical rod centerline when coupling the edge catching device and the level rod shaft member together.

In another aspect of the present invention, the attachment device comprises a threaded shaft having a top end and a bottom end, the threaded shaft about the top end engages a first vertical threaded hole along the vertical rod centerline and threaded shaft about the bottom end engages a second vertical threaded hole along the vertical device centerline, the first and second vertical threaded holes being configured to match the threaded shaft.

In another aspect of the present invention, the edge catching device further comprises an inner edge running across the bottom edge engaging bottom end and being configured to align the inner edge vertically through the vertical device centerline.

In another aspect of the present invention, the inner edge cuts across the edge engaging bottom end of the edge catching device is divided into an upper bottom edge and a lower bottom edge.

In another aspect of the present invention, the level rod shaft member and the edge catching device have identical dimensions.

In another aspect of the present invention, the level rod shaft member and the edge catching device are cylindrical having identical diameters.

In another aspect of the present invention, the level rod shaft member comprises a prism pole and a level rod.

In another embodiment of the present invention an edge catching device includes the edge engaging bottom end having an upper bottom edge and a lower bottom edge, an attachment threaded hole configures to couple to an attachment device along a vertical device centerline, and an inner edge running across the bottom edge engaging bottom end and being configured to align the inner edge vertically through the vertical device centerline.

In another aspect of the present invention, the edge catching device is configured to have identical dimension with a mating level rod shaft member.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates an example use of one embodiment of an article of manufacture providing an edge catching device for a surveyor’s prism pole according to the present invention.

FIG. 2 illustrates a side view of an article of manufacture for providing an edge catching device attached to a surveyor’s prism pole according to the present invention.

FIG. 3 illustrates another side view of an article of manufacture for providing an edge catching device for a surveyor’s prism pole according to the present invention.

FIG. 4 illustrates a bottom view of an article of manufacture for providing an edge catching device for a surveyor’s prism pole according to the present invention.

FIG. 5 illustrates a top view of an article of manufacture for providing an edge catching device for a surveyor’s prism pole according to the present invention.

### DETAILED DESCRIPTION

This application relates in general to an article of manufacture for providing a surveying device, and more specifically, to an article of manufacture providing an edge catching device for a surveyor’s prism pole according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual,” “surveyor,” and “user” refer to an entity, e.g., a human, using an article of manufacture providing an edge catching device for a surveyor’s prism pole according to the present invention. The term user herein refers to one or more users.

The term “invention” or “present invention” refers to the invention being applied for via the patent application with the title “Edge Catching Device.” Invention may be used interchangeably with pole device.

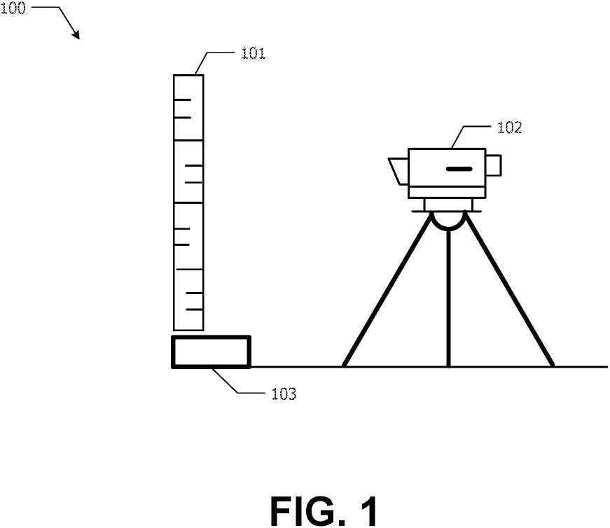

In general, the present disclosure relates to an article of manufacture providing an edge catching device for a surveyor’s prism pole according to the present invention. To better understand the present invention, FIG. 1 illustrates an example use of one embodiment of an article of manufacture providing an edge catching device for a surveyor’s prism pole according to the present invention. In their work, surveyors use the Global Positioning System (GPS), a system of satellites that locates reference points with a high degree of precision. Surveyors interpret and verify the GPS results. They gather the data that is fed into a Geographic Information System (GIS), which is then used to create detailed maps.

Surveyors also take measurements in the field with a crew, a group that typically consists of a licensed surveyor and trained survey technicians. These measurements may be used to calculate locations of many items relative to each other as well as relative to a known location or property line. When making these measurements, the surveyor uses a compass, a transit, a level, and a level rod or prism pole 101 having a point located at its bottom to measure changes in elevation for various points within an area being surveyed.

In order to use these tools 102 to accurately determine the distance, location, asthmas, and elevation change of an area, the surveyor will obtain measurements using these tools from multiple identifiable locations in an area. These identifiable locations are typically marked by objects 103 such as trees, boulders, and man-made objects such as curbs, sidewalks, and structures. To obtain measurements of these locations as accurately as possible, the level rod or prism pole needs to be positioned at one of these identifiable objects at a known position such as an edge of a curb or other object 103. Ensuring that the level rod or prism pole 101 is located at this edge of the object 103 determines the accuracy of the measurements.

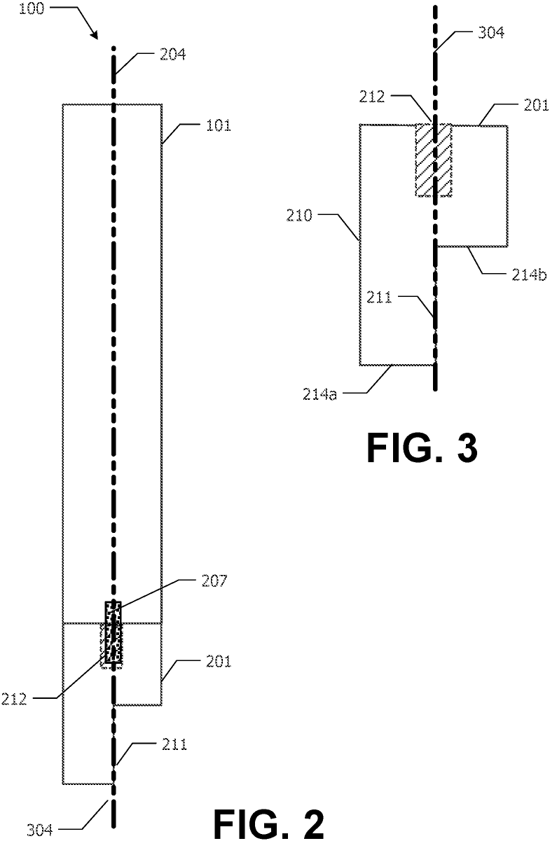

FIG. 2 illustrates a side view of an article of manufacture for providing an edge catching device attached to a surveyor’s prism pole according to the present invention. An edge catching level rod 100 having a level rod shaft member 202 and an edge catching device 201. The edge catching device 201 is shown coupled to a bottom edge of the level rod shaft member 202 to place the edge catching device 201 about a vertical device centerline 204 of the level rod or prism pole 101. The vertical device centerline 204 corresponds to an inner edge 211 of the edge catching device 201.

The surveyor may use the edge catching device 201 to ensure the centerline 204 of the level rod or prism pole 101 corresponds to a selected object 103 when a measurement is made using the level rod or prism pole 101. The edge catching device 201 may be placed on top of the object 103 with its inner edge 211 aligned with the edge of the object 103. As such, the surveyor may trust that any measurement made using the level rod or prism pole 101 will be aligned with an outer edge of the object 103.

The level rod or prism pole 101 may be coupled to the edge catching device 201 using an attachment device 207 such as a threaded screw or bolt that engages a threaded hole 212 into the edge catching device 201. When the edge catching device 201 and the level rod or prism pole 101 are manufactured, the attachment device 207 and the threaded hole 212 are placed at the center of the devices to align the level rod or prism pole 101 with the inner edge of the 211 of the edge catching device 201.

FIG. 3 illustrates another side view of an article of manufacture for providing an edge catching device for a surveyor’s prism pole according to the present invention. The edge catching device 201 is shown from a side view in which the inner edge 211 of the edge catching device 201 is perpendicular to the side view. This orientation illustrates the centerline 304 of the edge catching device 201 corresponds to the vertical rod centerline 204 of the level rod or prism pole 101 because the threaded hole 212 is also located along the vertical device centerline 204 of the edge catching device 201. If the threaded hole 212 is along the vertical device centerline 304 of the edge catching device 201 and if the attachment device 207 is installed into the level rod or prism pole 101 along its corresponding vertical rod centerline 204, the level rod or prism pole 101 and the edge catching device 201 will have their respective centerlines 204, 304 align to each other when the attachment device 207 couples to the threaded hole 212.

The inner edge 211 is oriented to cut the edge catching device 201 in half along the bottom end 214a-b. The inner edge 211 is configured to place the vertical device centerline 304 and the vertical rod centerline 204 along the inner edge. The inner edge 211 configured in this manner creates a notch in which the edge engaging bottom end 204a-b of the edge catching device 201 as the edge engaging bottom end is divided into an upper and lower bottom surface 214a-b. This notch created by the inner edge can be place onto and against an object 103 in the field. As such, when the edge catching device 201 is placed onto and against the object 103 in the field, the vertical device centerline 304 and the vertical rod centerline 204 also align with the location of the edge of the object 103 to provide an accurate location of the level rod 201 with respect to the object 103.

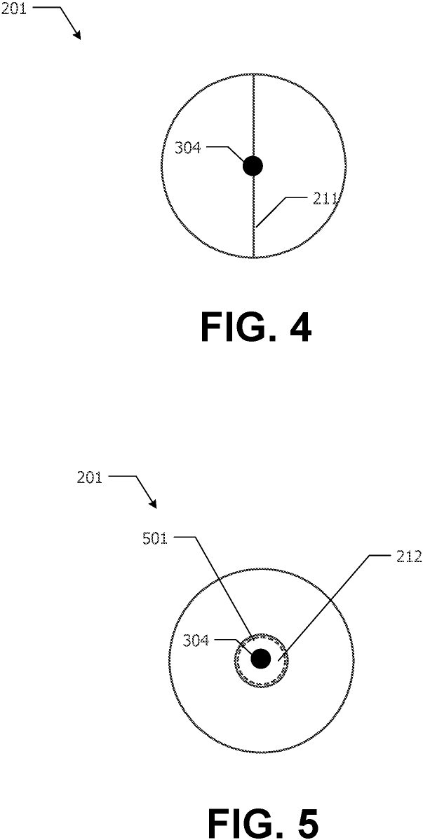

FIG. 4 illustrates a bottom view of an article of manufacture for providing an edge catching device for a surveyor’s prism pole according to the present invention. Similarly, FIG. 5 illustrates a top view of an article of manufacture for providing an edge catching device for a surveyor’s prism pole according to the present invention. In FIG. 4, the inner edge 211 is shown cutting the edge catching device 201 in half and having the centerline 304 correspond to the center of the inner edge 211. In FIG. 5, the threaded hole 212 is shown in the center of a top surface of the edge catching device 201. Once again, the centerline 304 of the edge catching device 201 is shown passing through the center of the threaded hole 212 and its corresponding threads 501.

In a preferred embodiment, the edge catching device 201 has an outside diameter of 2.5″ to match the diameter of the level rod or prism pole 101. The edge catching device 201 is 4.37″ in length with the inner edge 211 of the edge catching device 201 having a height of 1″. The threaded hole 212 is ⅝″ in diameter to match the threads of the attachment device 207. The edge catching device 201 may be made of wood with a metal threaded insert into the threaded hole 212.

One of ordinary skill in the art will recognize that the diameter of the edge catching device 201, its length, the inner surface height, and the threaded hole diameter are stated above for example purposes of a preferred embodiment. The edge catching device 201 may be scaled to match with any size pole while using different sized attachment devices depending upon the needs of a particular embodiment. The present invention is not intended to be limited by any of the above dimensions except as recited within the attached claims.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture providing an edge catching device for a surveyor’s level rod, the edge catching level rod comprises:
a level rod shaft member having a top end, a bottom end, and a vertical rod centerline;
an edge catching device having a top end, an edge engaging bottom end and a vertical device centerline; and
an attachment device coupling the bottom end of the level rod shaft member to the top end of the edge catching device.

2. The edge catching level rod according to claim 1, wherein the attachment device is configured to align the vertical device centerline and the vertical rod centerline when coupling the edge catching device and the level rod shaft member together.

3. The edge catching level rod according to claim 2, wherein the attachment device comprises a threaded shaft having a top end and a bottom end, the threaded shaft about the top end engages a first vertical threaded hole along the vertical rod centerline and threaded shaft about the bottom end engages a second vertical threaded hole along the vertical device centerline, the first and second vertical threaded holes being configured to match the threaded shaft.

4. The edge catching level rod according to claim 2, wherein the edge catching device further comprises an inner edge running across the bottom edge engaging bottom end and being configured to align the inner edge vertically through the vertical device centerline.

5. The edge catching level rod according to claim 4, wherein the inner edge cuts across the edge engaging bottom end of the edge catching device is divided into an upper bottom edge and a lower bottom edge.

6. The edge catching level rod according to claim 1, wherein the level rod shaft member and the edge catching device have identical dimensions.

7. The edge catching level rod according to claim 6, wherein the level rod shaft member and the edge catching device are cylindrical having identical diameters.

8. The edge catching level rod according to claim 1, wherein the level rod shaft member comprises a prism pole and a level rod.

9. An article of manufacture providing an edge catching device for a surveyor’s level rod, the edge catching device comprises:
a top end;
an edge engaging bottom end having an upper bottom edge and a lower bottom edge;
an attachment threaded hole configures to couple to an attachment device along a vertical device centerline; and
an inner edge running across the bottom edge engaging bottom end and being configured to align the inner edge vertically through the vertical device centerline.

10. The edge catching device according to claim 9, wherein the edge catching device is configured to have identical dimension with a mating level rod shaft member.

11. The edge catching level rod according to claim 10, wherein the level rod shaft member and the edge catching device are cylindrical having identical diameters.

12. The edge catching level rod according to claim 10, wherein the level rod shaft member comprises a prism pole and a level rod.
